(19) United States
(12) Patent Application Publication
(10) Pub. No.: US 2015/0172893 A1
(43) Pub. Date: Jun. 18, 2015

(54) Mobile Companion

(71) Applicants: Gerard St. Germain, San Clemente, CA (US); David Joseph Silvestris, Santee, CA (US)

(72) Inventors: Gerard St. Germain, San Clemente, CA (US); David Joseph Silvestris, Santee, CA (US)

(21) Appl. No.: 14/104,067

(22) Filed: Dec. 12, 2013

(51) Int. Cl. H04W 4/22; H04M 11/04

(52) U.S. Cl. CPC H04W 4/22; H04M 11/04; H04M 2242/04

(57) ABSTRACT

The Mobile Companion is a wrist or ankle worn device that combines the attributes of a watch, smartphone, pulse-oximeter, temperature monitor and accelerometer into a health monitoring device that can maintain and transmit both positional and medical conditions of the wearer. The System also has a programmable processing unit that can set parameters to allow the device to automatically alert military or civilian emergency services without the users input when certain emergency criteria is met. The System can also maintain full medical records for secured data transmission to authorized personnel.

### BACKGROUND OF THE INVENTION

This application claims the benefit of U.S. provisional application No. 61,735,141, filed Dec. 12, 2012, the entire contents of which are incorporated herein by this reference.

1. Field of Invention

The invention is in the technical field of personal medical monitoring devices.

The invention is also in the technical field of military targeting systems.

The invention is also in the technical field of encrypted military communications devices.

2. Introduction

There is a need for mobile wireless monitoring that is not tethered to a particular location, such as a medical facility or home based unit. The present invention, also referred to as the Mobile Companion, “MC” or the System, utilizes many standard medical monitoring and wireless technologies found in modern devices today. The Mobile Companion combines these systems into a compact wrist based monitoring & communications watch utilizing its proprietary software. The Mobile Companion combines the primary systems of a medical monitoring system, such as, but not limited to pulse-oximetry (Reflectance Pulse Oximetry—RPO), heart arrhythmia monitoring, body temperature and electrical impulse monitoring with the functions of a modern smart-phone, including but not limited to wireless technology, such as *Bluetooth®, **Wi-Fi®, and encrypted military wireless communications, location services, such as but not limited to GPS, accelerometer measurements, and wireless triangulation, and computational capabilities, such as but not limited to, programmability, algorithmic analysis, and digital processing. This allows for a continual monitoring and wireless transmission system to monitor personal health conditions, communications and location identification. (Bluetooth® is a registered certification mark of Bluetooth Sig, Inc., a Delaware corporation, for telecommunication and computer communication equipment and services, including receivable short-range wireless transmission. Wi-Fi® is a registered certification mark of the Wi-Fi Alliance. The Wi-Fi Alliance is a global non-profit industry association of hundreds of leading companies devoted to seamless connectivity. The Wi-Fi Alliance was formally known as the Wireless Ethernet Compatibility Alliance (WECA) but changed its name in October 2002.)

### SUMMARY

This System also allows for automated emergency response parameters to be set individually, to automatically send alert communications without the users input to emergency services upon certain programmed parameters. Examples of these parameter based emergency situations include but are not limited to; elderly falls, strokes, and heart attacks; infant monitoring, including but not limited to Sudden Infant Death Syndrome, water submersion, distance from another unit alarms, and falling off objects; high G-Force impact situations, including but not limited to car accidents, bicycle accidents, recreational vehicle accidents, and pedestrians being hit by vehicles; military personnel engagement incidents including but not limited to ballistic wounds, explosive force impact, high or low temperature emergency situations and other trauma situations. The Mobile Companion also has a touch screen user interface, micro forward facing and side mounted camera systems and the ability to monitor sounds in the area for emergency notification, such as but not limited to calls for help, gun fire and explosive noises.

Mobile Companion is intended to be worn on the wrist or ankle, but is not intended to be limited to this application only. The Mobile Companion of the present invention is a small wearable device that monitors, among other things but is not limited to, pulse-oximetry (Reflectance Pulse Oximetry—RPO), heart arrhythmia, body temperature and other electrical impulse monitoring. Heart arrhythmia (ECG/EKG—Electrocardiogram monitoring) can be accomplished by utilizing single lead, three lead or multiple lead tracking by using either multiple Mobile Companion units or an accompanying companion bracelet(s) to track electrical activity across the leads imbedded in the unit.

The System combines the primary functions of a modern smart-phone, including but not limited to wireless technology, such as Bluetooth®, Wi-Fi®, Cellular and encrypted military wireless communications, location services, such as but not limited to GPS, accelerometer measurements, and wireless triangulation, and computational capabilities, including but not limited to, programmability, algorithmic analysis, and digital processing.

The System uses computational algorithms to track health conditions and compare those to individually set parameters to determine if an emergency condition is occurring. If the parameters for an emergency condition have occurred then the system will take pre-programmed steps automatically to notify and transmit the emergency condition to the user, a predetermined social network and to emergency services respectively. This allows for a continual monitoring and wireless transmission system to monitor personal health conditions, communications and location identification.

This System also allows for automated emergency response parameters to be set individually, to automatically send alert communications without the users input to emergency services upon certain programmed parameters. Examples of these parameter based emergency situations include but are not limited to elderly falls, strokes, and heart attacks, infant monitoring, including but not limited to Sudden Infant Death Syndrome, water submersion, distance from another unit alarms, and falling off objects, high G-Force impact situations, including but not limited to car accidents, bicycle accidents, recreational vehicle accidents, and pedestrians being hit by vehicles, military personnel engagement incidents including but not limited to ballistic wounds, explosive force impact, high or low temperature emergency situations, and other trauma situations. The present invention also has a touch screen user interface, micro forward facing camera system and the ability to monitor sounds in the area for emergency notification, such as but not limited to calls for help, gun fire and explosive noises.

Mobile Companion maintains secured data including but not limited to both encrypted and non-encrypted data including but not limited to tracking data such as its own geographical location, magnetic orientation, and 4 axis positional coordinates, as well as personal data including but not limited to name, age, height, weight, and date of birth, as well as internal medical data including but not limited to blood type, inoculations, medications currently being taken, medication schedule, medication history, family medical history, surgical history, mental health history/condition, recreational drug use including but not limited to prescription and non-prescription drugs, and alcohol, as well as emergency social network notification systems, including but not limited to medical contacts , phone contacts, email contacts, SMS contacts, and physicians contacts

The System can transmit data through but not limited to its wired connections as well as wirelessly through but not limited to WiFi, Bluetooth, Cellular services, and military frequency transmissions to authorized third party receivers, including but not limited to personal computing systems such as mobile phones and tablet devices, as well as tactical operations centers (TOC) such as but not limited to emergency services, 911 systems, first responders, medical facilities, field medics, smart-litters, Joint Tactical Radio frequencies, and other military and civilian command centers.

The System has interchangeable internal memory units, processing units, and third-party connectors such as but not limited to GSM, micro-USB and micro-SSD memory cards. These memory and connection devices can be used to record or transmit data such as but not limited to location, health condition, high G-Force impact, ambient and internal body temperature and other monitored data.

Mobile Companion utilizes a rechargeable system of internal batteries that may be recharged by, but not limited to interchangeable battery systems, Micro-USB charging, and internal kinetic charging systems, as well as other external movement based charging systems, solar charging systems and third party charging systems.

Mobile Companion utilizes a programmable operating system that includes, but is not limited to, applications that can allow a soldier to tap on the touchscreen user interface in either Morse code or more simply used as an energy saving beacon, by turning off all features except location transmissions only upon screen taps. Other software applications include any application available to the commercial user as well as restricted military applications, such as but not limited to Connecting Soldiers to Digital Applications (CDSA). The software also may allow for designated trusted social networks, which designate specific individuals or designated trusted data collection services to track the user location, medical condition as well as other data, only by authorization. The software also allows for pin and false pin activation. This feature allows for only authorized users to activate the features of the present invention, as well as a false pin activation which sends false data to unauthorized individuals transferring misinformation as security option.

### BRIEF DESCRIPTION OF THE DRAWINGS

In order to describe the manner in which the above-recited features of the invention can be obtained, a more particular description of the invention is briefly described and rendered by reference to specific embodiments thereof which are illustrated in the appended drawings.

Understanding that these drawings depict only typical embodiments of the invention and are not therefore to be considered limiting of its scope, the invention will be described and explained with additional specificity and detail through the use of the accompanying drawings in which:

FIG. 1 is a diagrammatic overview of the present invention

FIG. 2 is a diagrammatic overview of the present invention as it pertains to tracking sensors.

### DETAILED DESCRIPTION

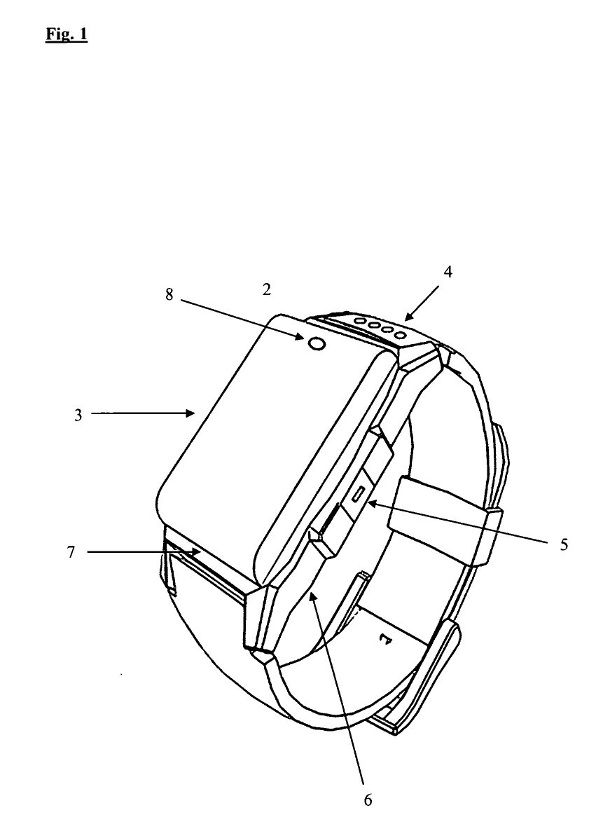

FIG. 1: Referring now to the invention in more detail, in FIG. 1 there is shown a Mobile Companion, 2, of the present invention. The present invention utilizes a touch screen graphical user interface, 3. The Mobile Companion utilizes both an internal rechargeable battery, as well as an external battery charging connecting points, 4. An external charge can also be fed to the present invention by way of the wired data transfer connection in the form of the MicroUSB connector, 5. The Mobile Companion maintains multiple sub-systems including accelerometer, GPS system, GMS chip slot, Micro SD memory slot, processing unit, WiFi, Bluetooth and cellular transmitter/receiver inside the primary casing, 6. A water resistant sealed casing is shown, 7 and front facing camera, 8

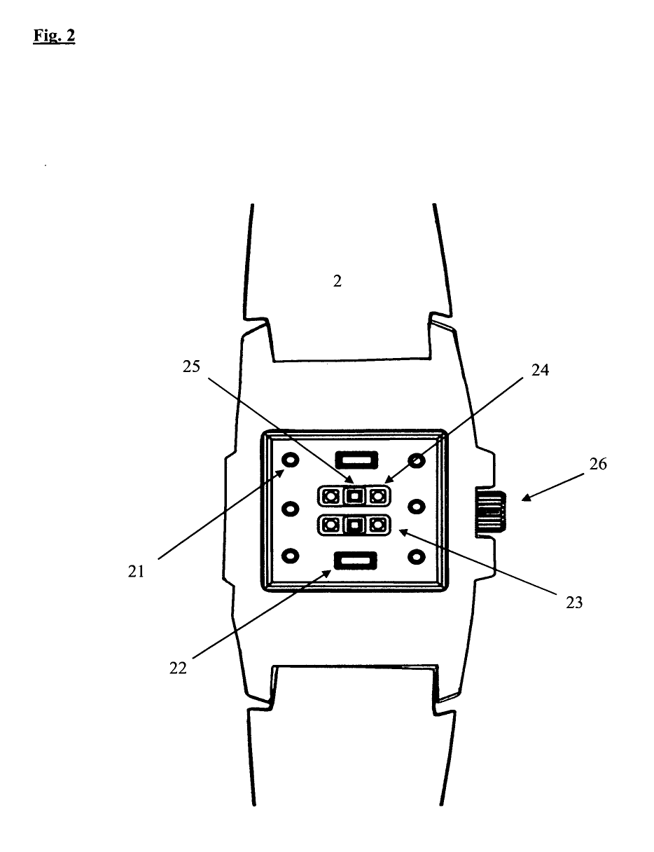

FIG. 2: In more detail, still referring to the Mobile Companion 2 of FIG. 2, in the example the present invention is further described by its tracking sensor systems, such as but not limited to both ambient and internal temperature sensors, 21, pulse/heart arrhythmia, 22, SpO2 (Oxyhemoglobin & Deoxyhemoglobin/Oxygen saturation levels), 23, a series of reflective light emitting diodes (LED), 24, including but not limited to 660 nanometer and 940 nanometer wavelengths, and receiving units, 25. The present invention also includes a side facing camera and lighting source, 26.

While the foregoing written description of the invention enables one of ordinary skill to make and use what is considered presently to be the best mode therof, those of ordinary skill will understand and appreciate the existence of variations, combination, and equivalents of the specific embodiment, method, and examples herein. The invention should therefore not be limited by the above described embodiment, method, and examples, but by all embodiments and methods within the scope and spirit of the invention.

1. A method for continuously monitoring a medical condition of a user, the method comprising:
providing a pulse-oximeter configured to continuously monitor the SpO2 and pulse of the user;
providing an skin temperature monitor configured to continuously monitor the user;
storing, using a memory coupled to the monitors, medical values that indicate an emergency state of the user;
continuously determining, using a processor, whether the medical condition of the user is within the medical values;
assigning, using the processor, an emergency code based on the medical condition of the user and the medical values;
determining, using a navigation unit, a current location of the processor; and transmitting, using the processor, via a cellular-based communications system, the emergency code and the current location to an emergency response provider;
transmitting, using the processor, via a wireless (WiFi®, Bluetooth® or Encrypted) based communications system, the emergency code and the current location to an emergency response provider.

2. The method of claim 1, wherein the unit is worn on the wrist un-tethered, allowing the user mobility.

3. The method of claim 1, wherein the unit is worn on the ankle un-tethered, allowing the user mobility.

4. The method of claim 1, wherein the unit is worn on the foot un-tethered, allowing the user mobility.

5. The method of claim 1, wherein the emergency code and the current location include real-time data.

6. The method of claim 1, wherein the current location includes digital positioning coordinates.

7. The method of claim 1, wherein the medical values includes timing, oxygen saturation levels, pulse rate/arrhythmia, ECG/EKG, temperature, and location data asset information.

8. The method of claim 1, wherein the optional device provides an ECG/EKG monitor configured to continuously monitor the user.

9. The method of claim 1, wherein the medical values include objective risk assessment information.

10. The method of claim 1, further comprising developing at least one of a mitigation strategy, response strategy, medical condition recognition strategy or target location analysis strategy.

11. A method for continuously monitoring for violent impacts of a user, the method comprising:
providing an accelerometer to continuously monitor a g-force of the user;
storing, using a memory coupled to the accelerometer, values that indicate an emergency state of the user;
continuously determining, using a processor, whether the g-force of the user is within dangerous values;
assigning, using the processor, an emergency code based on the g-force of the user and the values that indicate the emergency state of the user;
determining, using a navigation unit, a current location of the processor; and
transmitting, using the processor, via a cellular-based communications system, the emergency code and the current location to an emergency response provider.
transmitting, using the processor, via a wireless (WiFi®, Bluetooth® or Encrypted) based communications system, the emergency code and the current location to an emergency response provider.

12. The method of claim 11, wherein the unit is worn on the wrist un-tethered, allowing the user mobility.

13. The method of claim 11, wherein the unit is worn on the ankle un-tethered, allowing the user mobility.

14. The method of claim 11, wherein the unit is worn on the foot un-tethered, allowing the user mobility.

15. The method of claim 11, wherein the emergency code and the current location include real-time data.

16. The method of claim 11, wherein the current location includes digital positioning coordinates.

17. The method of claim 11, wherein the accelerometer values includes g-force, impact, and location data asset information.

18. The method of claim 11, wherein the accelerometer values include risk assessment information.

19. The method of claim 11, wherein the accelerometer values include objective risk assessment information.

20. The method of claim 11, further comprising developing at least one of a mitigation strategy, response strategy, impact condition recognition strategy or target location analysis strategy.
